(19) United States
(12) Patent Application Publication
(10) Pub. No.: US 2013/0290847 A1
(43) Pub. Date: Oct. 31, 2013

(54) SYSTEM AND METHOD FOR PROCESSING VIEWER INTERACTION WITH VIDEO THROUGH DIRECT DATABASE LOOK-UP

(71) Applicant: Paul Hooven, (US)

(72) Inventor: Paul Hooven, (US)

(21) Appl. No.: 13/460,441

(22) Filed: Apr. 30, 2012

(51) Int. Cl. G06F 3/01; G06F 17/30

(52) U.S. Cl. 715/719

(57) ABSTRACT

Embodiments of the present invention provide a non-transitory computer readable medium having computer executable program code embodied thereon, the computer executable program code configured to cause a computing device to: tag video content; create and maintain an online database of tagged products or points of interactivity and their associated actions; embed application software in a desired web page; cause the web browser to play the tagged video; cause a web application to record and analyze user activity; cause the web application to determine if user input corresponds to the time and location in the video where a product has been tagged; cause the web application to communicate with a home website; and cause the home website to compile user and product activity data.

### TECHNICAL FIELD

The present invention relates generally to online video, and more particularly to a system and method for processing viewer interaction with video through direct database look-up.

### DESCRIPTION OF THE RELATED ART

Conventional products that permit viewer interaction with online video for the purpose of the identification and interaction with products or other items suffer from two fundamental drawbacks. The first drawback of known products of this type is that a plug-in of some sort (typically Flash) is needed to capture user actions such as mouse clicks or mouse-overs. The second drawback of such products is that they require overlaying an intermediate layer to enable user interaction. In other words, there is no single element which can both capture user activity and display video data to the viewer.

In view of these drawbacks, there exists a long felt need for products that permit viewer interaction with online video, yet eliminate unnecessary complications including multi-layered video plug-ins and external media players. There further exists a need for functionality to be executed via all common web browsers, thereby enabling compatibility with mobile devices.

### BRIEF SUMMARY OF EMBODIMENTS OF THE INVENTION

Embodiments of the present invention provide systems and methods for processing viewer interaction with video through direct database look-up.

One embodiment involves a non-transitory computer readable medium having computer executable program code embodied thereon, the computer executable program code configured to cause a computing device to: tag video content; create and maintain an online database of tagged products or points of interactivity and their associated actions; embed application software in a desired web page; cause the web browser to play the tagged video; cause a web application to record and analyze user activity; cause the web application to determine if user input corresponds to the time and location in the video where a product has been tagged; cause the web application to communicate with a home website; and cause the home website to compile user and product activity data.

In the above computer readable medium, wherein the computer executable program code may further be configured to add points of interactivity to the video content by video tracking or manual addition of tags. Additionally, embedding the application software in the desired web page may comprise placing a block of HTML/JavaScript at a desired location in the web page. The web application is compatible with all web enabled devices because (i) the web browser itself plays the video file, and (ii) HTML5 allows the interaction with the video file. In some cases, the web application recording and analyzing user activity comprises the tagged video being drawn onto an HTML5 canvas element, whereby the canvas element records specific locations and times of significant events.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram depicting a system and method for processing viewer interaction with video through direct database look-up, in accordance with an embodiment of the invention.

FIG. 2 is a diagram illustrating the interaction between a video element and a canvas element, in accordance with an embodiment of the invention.

FIGS. 3-7 depict user workflow for interacting with video through direct database look-up, in accordance with an embodiment of the invention.

FIG. 8 is a diagram illustrating an exemplary computing module that may be used to implement any of the embodiments disclosed herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward systems and methods for processing viewer interaction with video through direct database look-up.

As used herein, the following terms shall be defined as set forth below.

A “canvas element” is a tag (e.g., in HTML version 5) used to draw graphics, on the fly, via scripting (usually JavaScript). The <canvas> tag is only a container for graphics, whereas the graphics themselves must be drawn using script.

The “context” is the portion of the HTML5 canvas element that contains and defines its contents. This includes the data that has been “drawn” on the canvas.

“HTML” is Hypertext Markup Language, a standardized system for tagging text files to achieve font, color, graphic, and hyperlink effects on World Wide Web pages.

“HTML5” is the fifth revision of HTML, which includes new syntax such as tags for video that is responsive and will also play in many browsers without requiring end users to install proprietary plug-ins.

“JavaScript” is a programming language that is mostly used in web pages, usually to add features that make the web page more interactive. When JavaScript is included in an HTML file, it relies upon the browser to interpret the JavaScript.

In computer programming, a “script” is a program or sequence of instructions that is interpreted or carried out by another program rather than by the computer processor.

A “video element” is a <video> tag (new in HTML5) that specifies video, such as a movie clip or other video streams, and provides a standard mechanism for web browser to play the video.

A “web browser” is a software application for retrieving, presenting, and traversing information resources on the World Wide Web.

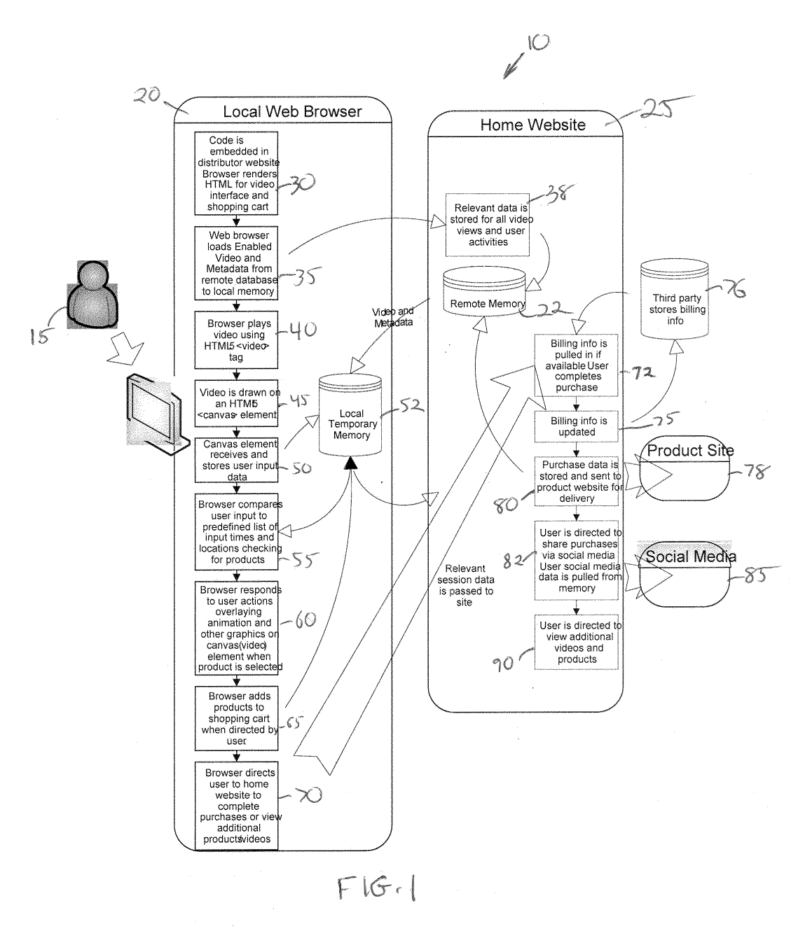

Referring to FIG. 1, a system and method for processing viewer interaction with video through direct database look-up will now be described. Specifically, the system and method 10 can be used by a user/viewer 15 for the purpose of playing online video directly from a local web browser 20 and providing a mechanism for monitoring user input. In particular, an online video file is played directly from the web browser 20 (e.g., using the HTML5 <video> tag). The video is then “drawn” onto the HTML5 <canvas> element. The canvas acts as an intermediate between the viewer 15 and the video file. This intermediate canvas can both display the video file, as well as monitor and record user input events. The user inputs are then compared directly against an array saved to local memory, and “interactable” items in the video can be identified, returned to the program, and displayed for the user. This is further described in the following method.

With further reference to FIG. 1, operation 30 involves the code being embedded in the distributor website such that the browser 20 renders HTML for the video interface and shopping cart. As such, the <video> element renders in the webpage's HTML. By utilizing this feature of HTML5, the browser itself plays the video file, thereby eliminating any need for external media players, and improving compatibility across varying media platforms, such as mobile devices. In operation 35, the web browser 20 loads the <canvas> element from a remote database to local memory, whereby relevant data is stored in remote memory 22 on home website 25 for all video views and user activities (operation 38). In operation 40, the web browser 20 plays the video using an HTML5 <video> tag. Specifically, a JavaScript script is written which locates the relevant HTML elements (video and canvas) their respective IDs (“v” and “c”), and returns the elements to the script code making them available for manipulation. A JavaScript event listener monitors incoming events searching for play events associated with the <video> element. When a play event is found, the designated

JavaScript code is executed by the browser 20.

With continued reference to FIG. 1, operation 45 entails the video play event being drawn onto the canvas element pixel by pixel, using the standard JavaScript drawimage method. In operation 50, the canvas element receives and stores user input data (in local temporary memory 52). More particularly, a JavaScript event listener monitors incoming events searching for click events (or other defined user inputs) associated with the <canvas> element. When an event is found, the time and position of the click are recorded and the designated JavaScript code is executed. In operation 55, the data saved for the click event is directly compared against a predefined array of timestamps and locations for which points of video interactivity exist. If a point of interactivity is found, the associated item code is returned. No real-time database access is needed to determine if a point of interactivity has been found, as the array is prepopulated asynchronously. In operation 60, when a point of interactivity is found, JavaScript code will respond in an appropriate, predefined way, likely altering the user experience to prompt further interaction with the selected item by enabling pop-ups, making hidden mark-up or prompts visible, or opening a new webpage.

With continued reference to FIG. 1, operation 65 involves the browser adding products to a shopping cart when directed by the user 15. In operation 70, the browser 20 directs the user 20 to home website 25 to complete the purchase or to view additional products and videos. Specifically, billing information is pulled in and the purchase is completed in operation 72. In operation 75, billing information is updated (and stored in third party database 76), while purchase data is stored and sent to the product website 78 for delivery in step 80. Operation 82 involves the user 15 being directed to share purchases via social media 85. Finally, in operation 90, the user 15 is directed to view additional videos and products.

In one embodiment of the invention, a system and method for enabling a video file for user interaction with video through direct database look-up comprises: (i) tagging of video content; (ii) creating and maintaining an online database of tagged products/interactivity points and their associated actions; (iii) embedding the application software in the desired web page; (iv) the web browser playing the tagged video; (v) the web application recording and analyzing user activity; (vi) the web application determining if user input corresponds to the time and location in the video where a product has been tagged; (vii) the web application communicating with the home website; and (viii) the home website compiling user and product activity data. With respect to (i) tagging of video content, points of interactivity (generally relating to products or services available for purchase) can be added to video content. This may be accomplished through a variety of techniques, including video tracking and manual addition of tags. Tagging is generally completed before the video content is released to distributors. In FIG. 1, tagging of video content occurs in operations 35 and 55.

Regarding (ii) creating and maintaining an online database of tagged products/interactivity points, these actions can be simple one-to-one correlations, or more complex logical formulas based on context, user demographics, and any other desired available data. In FIG. 1, these functions take place in operations 35 and 55. With respect to (iii) embedding the application software in the desired web page, a block of HTML/JavaScript can be delivered to the customer and placed at the desired location in the distributor's web page. The viewer's web browser locally processes the application code and render the user interface and shopping cart. In FIG. 1, embedding the application software in the desired web page occurs in operation 30. Regarding (iv) the web browser (e.g., local web browser 20) playing the tagged video, the application is compatible with all web enabled devices because the web browser itself plays the video file, and because HTML5 allows the interaction with the video file such that effects/animations are achieved via HTML5 techniques. In FIG. 1, the web browser playing the tagged video occurs in operations 40 and 45.

With respect to (v) the web application recording and analyzing user activity, the enabled video is drawn onto the HTML5 canvas element. The canvas then listens for a click, hover or other significant event, and records the specific locations and times of the actions. In response to user actions, the canvas element is utilized to overlay animations and graphical effects on top of the video. In FIG. 1, the web application recording and analyzing user activity occurs in operation 50. Regarding (vi) the web application determining if user input corresponds to the time and location in the video where a product has been tagged, the web application determines if user input corresponds to the time and location in the video where a product has been tagged. At the onset of the video (or periodically during viewing), the data file containing product tag data is loaded into local memory. This data contains product locations as well as predetermined response actions to be executed locally. In FIG. 1, this function occurs in operation 55. With respect to (vii) the web application communicating with the home website, at appropriate times the web application collects pertinent contextual data and user activity data. This data is sent securely to the home website. Users can also be directed to the home website at appropriate times, most notably for the completion of ecommerce activities. In FIG. 1, this function takes place in operation 70. With respect to (viii) the home website compiling user and product activity data, this data can be used for reporting and analytically purposes, as well as to tailor future content to a user's specific interests. In FIG. 1, the home website compiling user and product activity data occurs in operation 38.

Embodiments of the invention offer viewers the capability to point, click and purchase items appearing in online video content. Such items may include, but are not limited to, clothes, food/beverage, tech products and soundtracks.

According to embodiments of the invention, the interface and workflow are designed to provide at your fingertips power with minimal disruption to the viewing experience. In one such embodiment, the interface is readily accessible and intuitively controlled when a viewer, through clicking on or mousing-over video content, initiates an encounter. The interface is otherwise unobtrusive.

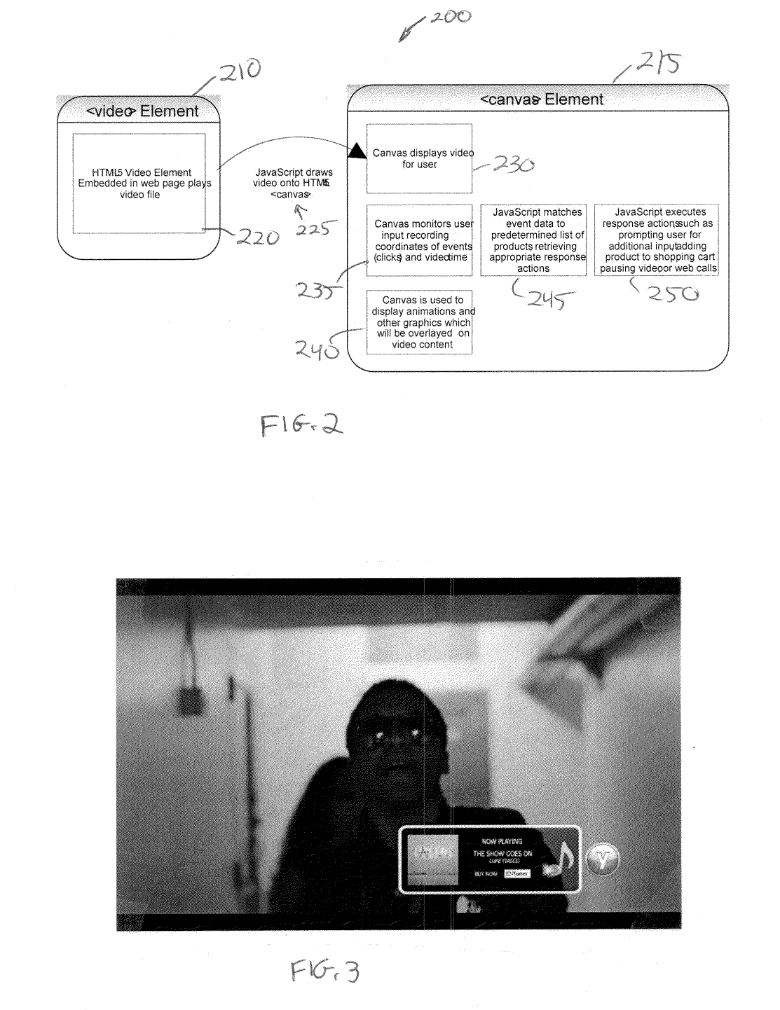

FIG. 2 is a diagram 200 illustrating the interaction between a video element 210 and a canvas element 215, in accordance with an embodiment of the invention. Specifically, operation 220 entails the HTML5 video element embedded within the web page playing the video file. In operation 225, JavaScript draws the video onto the HTML5 canvas. In operation 230, the canvas displays the video for the user. the canvas element may additionally (i) monitor user input, e.g. by recording (x,y) coordinates of events (clicks) and video time (operation 235), and (ii) display animations and other graphics that are overlayed on video content (operation 240). The JavaScript (i) matches event data to a predetermined list of products retrieving appropriate response actions (operation 245), and (ii) executes response actions such as prompting the user for additional input, adding products to the shopping cart, pausing the video, web calls, etc. (operation 250).

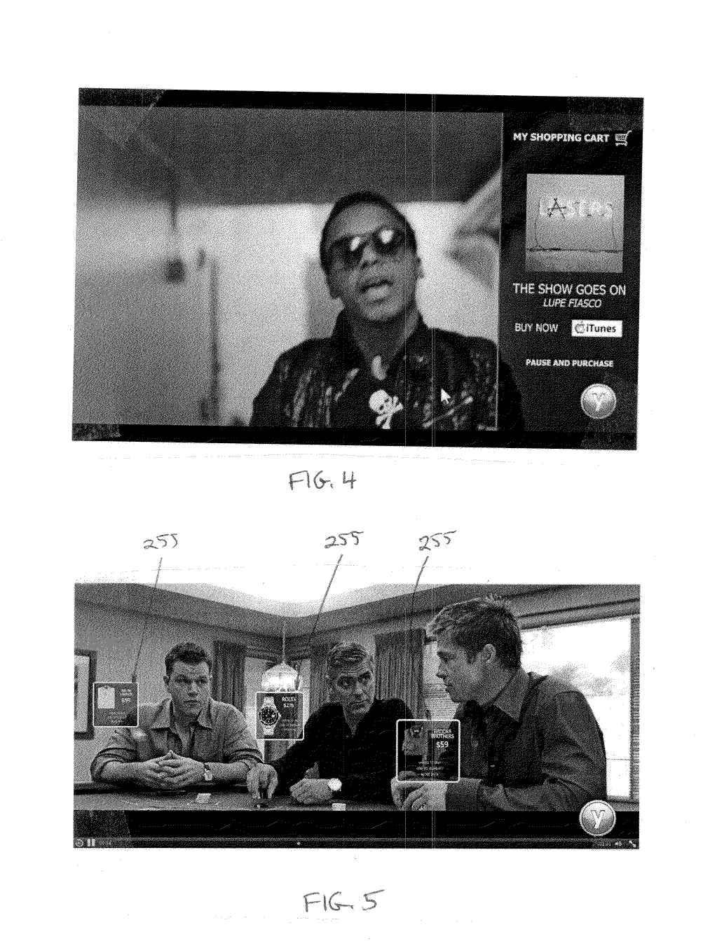

Referring to FIGS. 3-7, the user workflow for interacting with video through direct database look-up will now be described. Initially, the user chooses to view a video enabled with direct database lookup. This may occur, for example, on a content distribution site, but take place on a variety of platforms. In the next step, the user interface is rendered by the web browser. By way of example, the interface may consist of a collapsed shopping cart interface positioned immediately to the right of the video player. The shopping cart expands upon a mouse-over or click. Additionally, semi-transparent icons may be overlayed on the video in order to remind users of system capabilities and to denote potential actions. This initial state is illustrated in FIGS. 3 and 4.

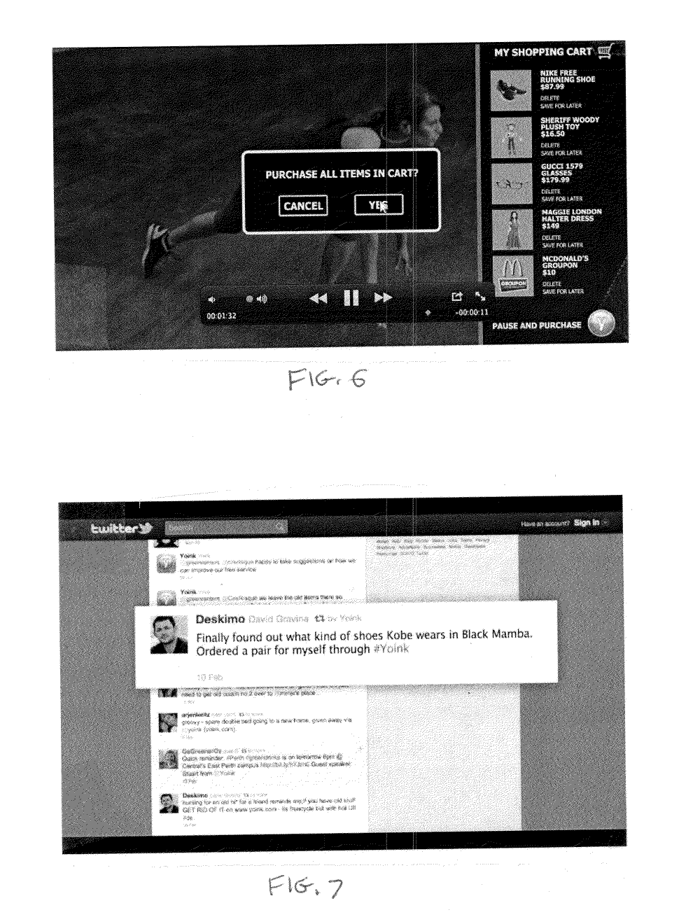

The next step in the user workflow for interacting with video through direct database look-up entails displaying user education and training content. In some cases, a short video clip (e.g., 1.5 seconds) may be included at the beginning of the video content demonstrating and explaining clickable functionality, as well as introducing proprietary icons and brands. A phrase such as, “Select items in this video to learn more” may then be displayed. Additionally, transparent icons denoting clickable items may be overlayed in the margins of the video as the products appear in the video. In the next step, the user's actions trigger graphical responses. Upon mouse-over, click or pausing of the video content, points of interactivity are denoted via semi-transparent, temporary pop-ups. These pop-ups (such as pop-ups 255 depicted in FIG. 5) inform users of basic product information and options for further actions.

The next step in the user workflow involves the user selection triggering a response. Although a variety of responses to a large number of selections are possible within the scope of the invention, a response may involve the instant purchase of a product, or the addition of a product to the shopping cart. When beneficial, these actions can be accompanied by simple animations and other graphical effects. Such effects are intended to guide the user through the workflow with minimal intrusion on their viewing experience. Special attention is paid to artistic design throughout the process leading to a sleek, clean, and fun aesthetic experience. As depicted in FIG. 6, the user subsequently completes and confirms the purchase. Billing and shipping information can be stored and retrieved when possible to simplify the purchasing process. This operation can be configured to pause the video content if desired. FIG. 7 depicts the user sharing purchases via social media. Social media information is stored and retrieved when possible.

According to another embodiment of the invention, a system and method for producing a video featuring direct database look-up will now be described. An initial step may entail identifying and cataloguing products. For each product, the following pieces of information can be recorded in a standardized document provided to the customer: (i) brief description, (ii) timestamps of appearance in the video, (iii) desired user interface action, and (iv) desired web-service action. The desired user interface action includes how the user interface reacts to a user click. Standard configurations include, without limitation: pop-up/mouse over, pausing of video file, save product to shopping cart, display of additional options such as purchase, read reviews, etc. Desired web-service actions are the automated actions the system may take in response to the user choosing a product. Such actions include, but are not limited to, storing user demographics at the time of clicking and directing a user to an advertisement/website. The next step involves tagging the video with “points of interactivity,” in order to produce a video file in which a tag including software code is embedded at each desired point of interaction. This code, representing a product, is returned to the application at the time of a user click during viewing.

The next step in the method for producing a video featuring direct database look-up entails a database build. In particular, while video tagging is taking place, a database can be populated to store relevant data associated with each embedded code. This code metadata may be used to define appropriate actions for the application and website in response to a user click, and a small amount of this data can be readily available to a local machine. By way of example, this information may be used to govern media player interactions, pop-ups, and other real-time activities. The majority of this data can be stored externally. After the database is constructed, the components of the enabled video file are combined into a customer ready version. This file may include: (i) video, (ii) product tags (codes), (iii) code metadata, (iv) identifiers, and (v) a consumer instruction clip. This working prototype is then delivered to the customer, and feedback is solicited. In addition, the video and each point of interactivity is thoroughly tested. Modifications and corrections are made as needed, based on quality assurance and customer feedback. After quality assurance and customer sign-off are completed, the video file is delivered to the customer. A release date is set, at which time associated functionality becomes active. All user activity can be tracked and stored, available ad hoc to customers, and also delivered at agreed upon intervals. Modifications to user click reactions and addition of interactivity points and new products are possible by changing the associated video metadata at any time.

Although the embodiments set forth hereinabove can be coded using HTML5 techniques and Javascript languages, additional embodiments cam be implemented using a wide variety of alternative programming languages and techniques, without departing from the scope of the present invention.

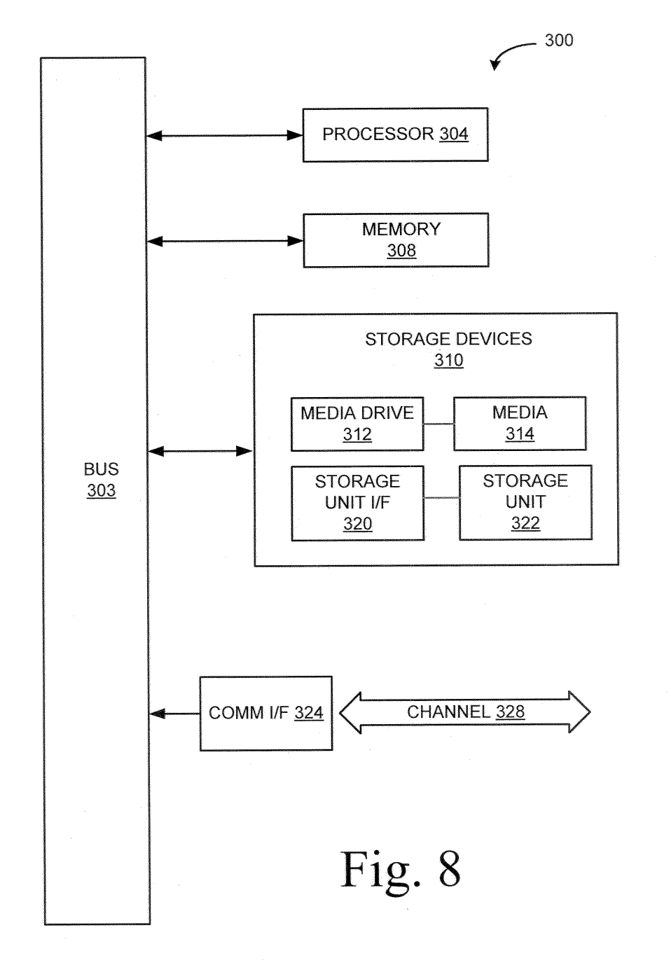

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements; and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 300. After reading this description, it will become apparent to a person skilled in the relevant art how to implement the invention using other computing modules or architectures.

Referring now to FIG. 8, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 303, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 303 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD, DVD or Blu-ray drive (R or RW), or other removable or fixed media drive might be provided. Accordingly, storage media 314 might include, for example, a hard disk, a floppy disk, magnetic tape, cartridge, optical disk, a CD, DVD or Blu-ray, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired, features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system for enabling a video file for user interaction with video through direct database look-up, comprising:
a processor; and
at least one computer program residing on the processor;
wherein the computer program is stored on a non-transitory computer readable medium having computer executable program code embodied thereon, the computer executable program code configured to:
tag video content;
create and maintain an online database of tagged products or points of interactivity and their associated actions;
embed application software in a desired web page;
cause the web browser to play the tagged video;
cause a web application to record and analyze user activity;
cause the web application to determine if user input corresponds to the time and location in the video where a product has been tagged;
cause the web application to communicate with a home website; and
cause the home website to compile user and product activity data.

2. The system of claim 1, wherein the computer executable program code is further configured to add points of interactivity to the video content by video tracking or manual addition of tags.

3. The system of claim 1, wherein embedding the application software in the desired web page comprises placing a block of HTML/JavaScript at a desired location in the web page.

4. The system of claim 1, wherein the web application is compatible with all web enabled devices.

5. The system of claim 1, wherein the web browser itself plays the video file.

6. The system of claim 1, wherein the use of HTML5 allows the interaction with the video file.

7. The system of claim 1, wherein the web application recording and analyzing user activity comprises the tagged video being drawn onto an HTML5 canvas element, whereby the canvas element records specific locations and times of significant events.

8. A non-transitory computer readable medium having computer executable program code embodied thereon, the computer executable program code configured to cause a computing device to:
tag video content;
create and maintain an online database of tagged products or points of interactivity and their associated actions;
embed application software in a desired web page;
cause the web browser to play the tagged video;
cause a web application to record and analyze user activity;
cause the web application to determine if user input corresponds to the time and location in the video where a product has been tagged;
cause the web application to communicate with a home website; and
cause the home website to compile user and product activity data.

9. The computer readable medium of claim 8, wherein the computer executable program code is further configured to acid points of interactivity to the video content by video tracking or manual addition of tags.

10. The computer readable medium of claim 8, wherein embedding the application software in the desired web page comprises placing a block of HTML/JavaScript at a desired location in the web page.

11. The computer readable medium of claim 8, wherein the web application is compatible with all web enabled devices.

12. The computer readable medium of claim 8, wherein the web browser itself plays the video file.

13. The computer readable medium of claim 8, wherein the use of HTML5 allows the interaction with the video file.

14. The computer readable medium of claim 8, wherein the web application recording and analyzing user activity comprises the tagged video being drawn onto an HTML5 canvas element, whereby the canvas element records specific locations and times of significant events.
